(19) United States
(12) Patent Application Publication
(10) Pub. No.: US 2016/0003255 A1
(43) Pub. Date: Jan. 7, 2016

(54) FLUID PROCESSING SYSTEM, AN ENERGY-DISSIPATING DEVICE, AND AN ASSOCIATED METHOD THEREOF

(71) Applicant: GENERAL ELECTRIC COMPANY, Schenectady, NY (US)

(72) Inventors: Jorgen Harald Corneliussen, Kolsas (NO); John Daniel Friedemann, Sandvika (NO)

(21) Appl. No.: 14/490,183

(22) Filed: Sep. 18, 2014

Related U.S. Application Data
(60) Provisional application No. 62/020,440, filed on Jul. 3, 2014.

(51) Int. Cl. F04D 13/02; F15D 1/14; F04D 17/08; F04D 25/02; B01D 19/00; F04D 1/00

(52) U.S. Cl. CPC F04D 13/02; B01D 19/0068; B01D 19/0073; F04D 1/00; F04D 17/08; F04D 25/02; F15D 1/14

(57) ABSTRACT

An energy-dissipating device and fluid processing system is provided containing a compressor, a motor, a secondary fluid re-circulation loop, a purge line, and a fluid conduit. The compressor is configured to receive a hot fluid including condensable and non-condensable components, and produce therefrom a primary compressed fluid stream and a secondary fluid stream. The motor is configured to drive the compressor and for ingress and egress of the secondary fluid stream. The secondary fluid re-circulation loop is configured to control an operating temperature of the motor. The secondary fluid re-circulation loop includes a first energy-dissipating device configured to remove excess heat from the secondary fluid stream. The purge line separates a first portion of the secondary fluid stream in the fluid re-circulation loop from a second portion of the secondary fluid stream being returned to the motor. The fluid conduit receives the primary compressed fluid stream from the compressor.

### CROSS REFERENCE TO RELATED APPLICATIONS

This application claims priority under 35 U.S.C. §119(e) from Provisional Application No. 62/020,440 filed on 3 Jul. 2014, which is incorporated by reference herein in its entirety.

### BACKGROUND

The present invention relates to fluid processing systems for deployment in subsea environments, and energy-dissipating devices used in such fluid processing systems.

Fluid processing systems used for hydrocarbon production in subsea environments typically include a main separator assembly and a heat exchange system disposed upstream relative a compressor. The heat exchange system reduces temperature of a multiphase fluid extracted from a subsea hydrocarbon reservoir. The main separator assembly receives the multiphase fluid from the heat exchange system and separates gaseous components from liquid components of the multiphase fluid.

In such fluid processing systems motors may be provided to drive the compressor which is configured to boost the multiphase fluid from the subsea environment to a distant storage facility. Typically, an operating temperature of such motors is controlled by circulating the multiphase fluid within the motors. However, the multiphase fluid may foul or scale the motor and flow paths leading to it. Further, a separate boosting device such as a liquid pump may be required to pump produced fluids (e.g. a liquid component of the multiphase fluid) to the distant storage facility. Also, there may be a need for a mixer to mix the separated gaseous components and the liquid components to enable delivery of the produced fluids to the distant storage facility.

Despite the impressive achievement made to date, there remains a need for improved fluid processing systems for more efficiently handling a multiphase fluid being produced from a subsea environment as well as improved energy-dissipating devices for use in such fluid processing systems.

### BRIEF DESCRIPTION

In one embodiment, the present invention provides a fluid processing system comprising: (a) a compressor configured to receive a hot fluid comprising condensable and non-condensable components, and produce therefrom a primary compressed fluid stream and a secondary fluid stream; (b) a motor configured to drive the compressor, the motor being configured for ingress and egress of the secondary fluid stream; (c) a secondary fluid re-circulation loop configured to control an operating temperature of the motor, the secondary fluid re-circulation loop comprising a first energy-dissipating device configured to remove excess heat from the secondary fluid stream; (d) a purge line configured to separate a first portion of the secondary fluid stream in the fluid re-circulation loop from a second portion of the secondary fluid stream being returned to the motor; and (e) a fluid conduit configured to receive the primary compressed fluid stream from the compressor.

In another embodiment, the present invention provides a fluid processing system comprising: (a) a compressor configured to receive a hot fluid comprising condensable and non-condensable components, and produce therefrom a primary compressed fluid stream and a secondary fluid stream; (b) a first energy-dissipating device configured to receive the secondary fluid stream and produce therefrom a tertiary fluid stream having a lower temperature than the secondary fluid stream; (c) a motor configured to drive the compressor, the motor being configured for ingress and egress of the tertiary fluid stream; (d) a tertiary fluid re-circulation loop configured to control an operating temperature of the motor, the tertiary fluid re-circulation loop comprising a second energy-dissipating device configured to remove excess heat from the tertiary fluid stream; (e) a purge line configured to separate a first portion of the tertiary fluid stream in the fluid re-circulation loop from a second portion of the tertiary fluid stream being returned to the motor; and (f) a fluid conduit configured to receive the primary compressed fluid stream from the compressor.

In yet another embodiment, the present invention provides a method comprising: (a) introducing a hot fluid comprising condensable and non-condensable components into a compressor to produce a primary compressed fluid stream and a secondary fluid stream; (b) feeding the secondary fluid stream from the compressor to a motor configured to drive the compressor, to control an operating temperature of the motor; (c) circulating the secondary fluid stream in a secondary fluid re-circulation loop configured to receive the secondary fluid stream from the motor, the secondary fluid re-circulation loop comprising an energy-dissipating device configured to remove excess heat from the secondary fluid stream; (d) separating a first portion of the secondary fluid stream from a second portion of the secondary fluid stream via a purge line; (e) re-circulating the second portion of the secondary fluid stream to the motor; and (f) transporting the primary compressed fluid stream from the compressor to a fluid storage facility via a fluid conduit.

In yet another embodiment, the present invention provides a method comprising: (a) introducing a hot fluid comprising condensable and non-condensable components into a compressor to produce a primary compressed fluid stream and a secondary fluid stream; (b) feeding the secondary fluid stream from the compressor to a first energy-dissipating device configured to remove heat from the secondary fluid stream and condense one or more condensable components of the secondary fluid stream, and to produce thereby a tertiary fluid stream depleted in condensable components and having a lower temperature than the secondary fluid stream; (c) feeding the tertiary fluid stream to a motor configured to drive the compressor, to control an operating temperature of the motor; (d) circulating the tertiary fluid stream in a tertiary fluid re-circulation loop configured to receive the tertiary fluid stream from the motor, the tertiary fluid re-circulation loop comprising a second energy-dissipating device configured to remove excess heat from the tertiary fluid stream; (d) separating a first portion of the tertiary fluid stream from a second portion of the tertiary fluid stream via a purge line; (e) re-circulating the second portion of the tertiary fluid stream to the motor; and (f) transporting the primary compressed fluid stream from the compressor to a fluid storage facility via a fluid conduit.

### DRAWINGS

These and other features and aspects of embodiments of the present invention will become better understood when the following detailed description is read with reference to the accompanying drawings in which like characters represent like parts throughout the drawings, wherein:

FIG. 1 illustrates a schematic view of a fluid processing system in accordance with one exemplary embodiment;

FIG. 2 illustrates a schematic view of the fluid processing system having a plurality of compressors in accordance with the exemplary embodiment of FIG. 1;

FIG. 3 illustrates a schematic view of the fluid processing system having the plurality of compressors, a plurality of motors, and a plurality of energy-dissipating devices in accordance with the exemplary embodiments of FIGS. 1 and 2;

FIG. 4 illustrates a schematic view of a fluid processing system in accordance with another exemplary embodiment;

FIG. 5 illustrates a schematic view of the fluid processing system having a flow control valve in accordance with the exemplary embodiment of FIG. 4;

FIG. 6 illustrates a schematic view of the fluid processing system having an energy-dissipating device disposed upstream of a compressor in accordance with the exemplary embodiment of FIG. 4;

FIG. 7 illustrates a schematic view of a fluid processing system in accordance with yet another exemplary embodiment;

FIG. 8 illustrates a schematic view of the fluid processing system having a plurality of compressors in accordance with the exemplary embodiment of FIG. 7;

FIG. 9 illustrates a schematic view of the fluid processing system having the plurality of compressors, a plurality of motors, and a plurality of energy-dissipating devices in accordance with the exemplary embodiments of FIGS. 7 and 8;

FIG. 10 illustrates a schematic view of the fluid processing system having a flow control valve in accordance with the exemplary embodiment of FIG. 7; and

FIG. 11 illustrates a schematic view of the fluid processing system having an energy-dissipating device disposed upstream of a compressor in accordance with the exemplary embodiments of FIGS. 7 and 10.

### DETAILED DESCRIPTION

Embodiments discussed herein disclose a new configuration of a fluid processing system for efficiently moving multiphase fluid being produced from a subsea hydrocarbon reservoir to a distant fluid storage facility. The fluid processing system of the present invention comprises an energy-dissipating device disposed upstream and/or downstream relative to a compressor and a fluid re-circulation loop. The energy-dissipating device comprises at least one of a heat exchange sub-system, a work extraction device, and a pressure changing device. The energy-dissipating device is configured to remove excess heat from a fluid stream and produce therefrom a first portion of a cold fluid stream enriched in condensable components and a second portion of the cold fluid stream depleted in condensable components. The re-circulation loop is configured to control an operating temperature of a motor configured to drive the compressor, by re-circulating the second portion of the cold fluid stream to the motor.

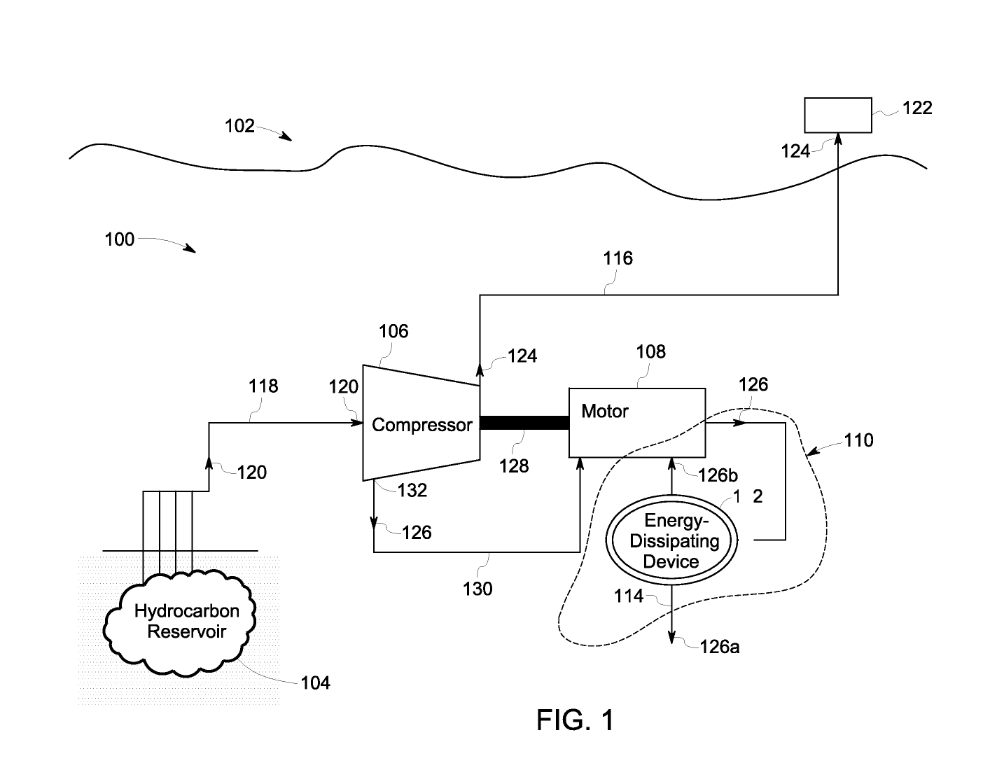

FIG. 1 represents a fluid processing system 100 deployed in a subsea environment 102. The fluid processing system 100 may be located at depths reaching several thousands of meters within a cold ambient environment and proximate to a subsea hydrocarbon reservoir 104. In one embodiment, the fluid processing system 100 includes a compressor 106, a motor 108, a secondary fluid re-circulation loop 110, an energy-dissipating device 112, a purge line 114, and a fluid conduit 116. The fluid processing system 100 further includes an import line 118 (i.e. inlet fluid conduit) coupled to the compressor 106. The inlet fluid conduit 118 and the fluid conduit 116 (i.e. outlet fluid conduit) may also be referred as “pipelines”. The fluid processing system 100 is configured to move a hot fluid 120, for example, a crude multiphase hydrocarbon fluid, being produced from the subsea hydrocarbon reservoir 104 to a distant fluid storage facility 122 more efficiently than using known production techniques.

The compressor 106 receives the hot fluid 120 from the subsea hydrocarbon reservoir 104 via the import line 118. The hot fluid 120 is typically a mixture of a hot gaseous fluid and a hot liquid fluid. The hot fluid 120 includes condensable components such as moisture and low molecular weight hydrocarbons, and non-condensable components such as the gases, CO₂ and H₂S. The compressor 106 is a wet gas compressor and is configured to compress the hot fluid 120 saturated with one or more condensable components and produce therefrom a primary compressed fluid stream 124 and a secondary fluid stream 126. The motor 108 is coupled to the compressor 106 via a shaft 128, and is configured to drive the compressor 106. In one or more embodiments, suitable compressors 106 include positive displacement compressors and centrifugal compressors.

The compressor 106 discharges the secondary fluid stream 126 to the motor 108 via a conduit 130. In one embodiment, the secondary fluid stream 126 may be discharged from an initial stage 132 of the compressor 106. The secondary fluid stream 126 is circulated within the motor 108, and is discharged from the motor 108 to the secondary fluid re-circulation loop 110. The secondary fluid stream 126 acts to cool the motor 108 while circulating within it.

The secondary fluid re-circulation loop 110 includes the energy-dissipating device 112 which receives the secondary fluid stream 126 from the motor 108. The energy-dissipating device 112 removes excess heat (i.e. heat extracted from the motor 108) from the secondary fluid stream 126 and produces a first portion 126a of the secondary fluid stream 126, and a second portion 126b of the secondary fluid stream 126. The first portion 126a is primarily a condensate, and the second portion 126b is primarily a gaseous fluid stream. In general, the first portion 126a is enriched in condensable components and the second portion 126b is depleted in condensable components. In one embodiment, the first portion 126a is naturally discharged from the purge line 114 into the feed line 118 (which may be alternatively referred as “a low pressure sink” or “a low pressure destination”). In certain other embodiments, the first portion 126a may be transported to a high pressure sink such as the outlet fluid conduit 116 located downstream of the compressor 106, through a boosting device (not shown in FIG. 1) disposed within the purge line 114.

In one embodiment, the energy-dissipating device 112 is a heat exchange sub-system configured to remove excess heat from the secondary fluid stream 126 by condensing at least a portion of the condensable components in the secondary fluid stream 126 and produce therefrom the first portion 126a and the second portion 126b. In one or more embodiments, the heat exchange sub-system may have an inlet header, an outlet header, and a plurality of heat exchange tubes. In such embodiments, the inlet header may receive the secondary fluid stream 126 discharged from the motor 108, circulate the secondary fluid stream 126 within the plurality of heat exchange tubes so as to exchange heat with the cold ambient environment, and condense at least a portion of the condensable components to produce therefrom the first portion 126a and the second portion 126b. Further, the plurality of heat exchange tubes may discharge the first and second portions 126a, 126b to the outlet header including a liquid-gas separator (i.e. purge line) for separating the first portion 126a from the second portion 126b. In certain other embodiments, the heat exchange sub-system may include a plurality of heat exchange tubes and a liquid-gas separator may be disposed along a length of the tubes. In such embodiments, the plurality of heat exchange tubes may receive the secondary fluid stream 126 discharged from the motor 108, cool the secondary fluid stream 126 and produce therefrom the first portion 126a and the second portion 126b of the secondary fluid stream 126, and separate the first portion 126a from the second portion 126b via the liquid-gas separator disposed within the tubes.

In another embodiment, the energy-dissipating device 112 is a work extraction device configured to remove heat from the secondary fluid stream 126 by expanding the secondary fluid stream 126 and produce therefrom the first portion 126a and the second portion 126b. Suitable work extraction devices include turbo-expanders, hydraulic expanders, and hydraulic motors. In yet another embodiment, the energy-dissipating device 112 is a pressure changing device configured to remove heat from the secondary fluid stream 126 by reducing pressure of the secondary fluid stream 126 and/or increasing friction in a flow of the secondary fluid stream 126 and produce therefrom the first portion 126a and the second portion 126b. In one embodiment, the pressure changing device is a throttle valve. As noted, the pressure changing device may also comprise a frictional loss device.

The purge line 114 coupled to the energy-dissipating device 112 separates the first portion 126a of the secondary fluid stream 126 from the second portion 126b of the secondary fluid stream 126. The purge line 114 may include a separator (not shown in FIG. 1) for separating the first portion 126a of the secondary fluid stream 126 from the second portion 126b of the secondary fluid stream 126. In one or more embodiments, the separator includes one or more weir separators, filter separators, cyclone separators, sheet metal separators, or a combination of two or more of the foregoing separators.

In one or more embodiments, the first portion 126a of the secondary fluid stream 126 may be safely discharged from the fluid processing system 100 into the subsea environment 102, for example, in instances wherein the first portion 126a is comprised of environmentally benign components such as water and/or carbon dioxide. In some other embodiments, the purge line 114 may deliver the first portion 126a to a feed line 118 (i.e. inlet fluid conduit) disposed upstream relative to the compressor 106. Similarly, in the illustrated embodiment, the second portion 126b is re-circulated to the motor 108 via the re-circulation loop 110 so as to control the operating temperature of the motor 108.

The outlet fluid conduit 116 is coupled to the compressor 106 for receiving the primary compressed fluid stream 124 from the compressor 106 and directing the primary compressed fluid stream 124 to the distant fluid storage facility 122.

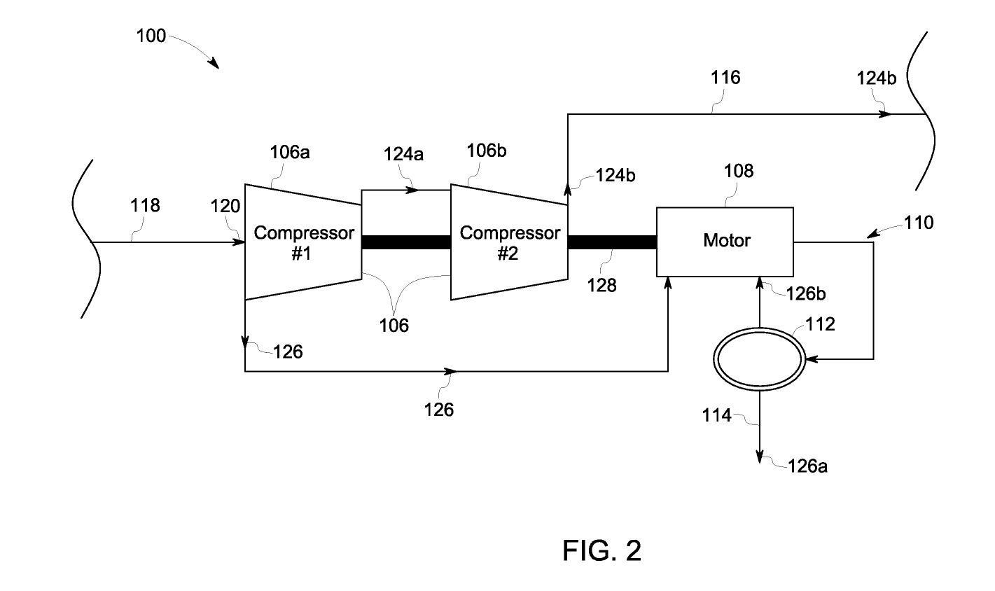

FIG. 2 represents the fluid processing system 100 having a plurality of compressors 106 in accordance with the exemplary embodiment of FIG. 1. The plurality of compressors 106 includes a first compressor 106a and a second compressor 106b deployed in series via the shaft 128 coupled to the motor 108.

In the illustrated embodiment, the first compressor 106a receives the hot fluid 120 from the subsea hydrocarbon reservoir 104 (as shown in FIG. 1) via the import line 118. The first compressor 106a is configured to compress the hot fluid 120 and produce therefrom a first primary compressed fluid stream 124a and the secondary fluid stream 126. The first compressor 106a is driven by the motor 108 via the shaft 128. The first primary compressed fluid stream 124a is fed to the second compressor 106b for further compression of the first primary compressed fluid stream 124a. The motor 108 is configured for ingress and egress of the secondary fluid stream 126. The second compressor 106b is also driven by the motor 108 via the shaft 128. The second compressor 106b produces a second primary compressed fluid stream 124b which is directed to the distant fluid storage facility 122 (as shown in FIG. 1) via the outlet fluid conduit 116.

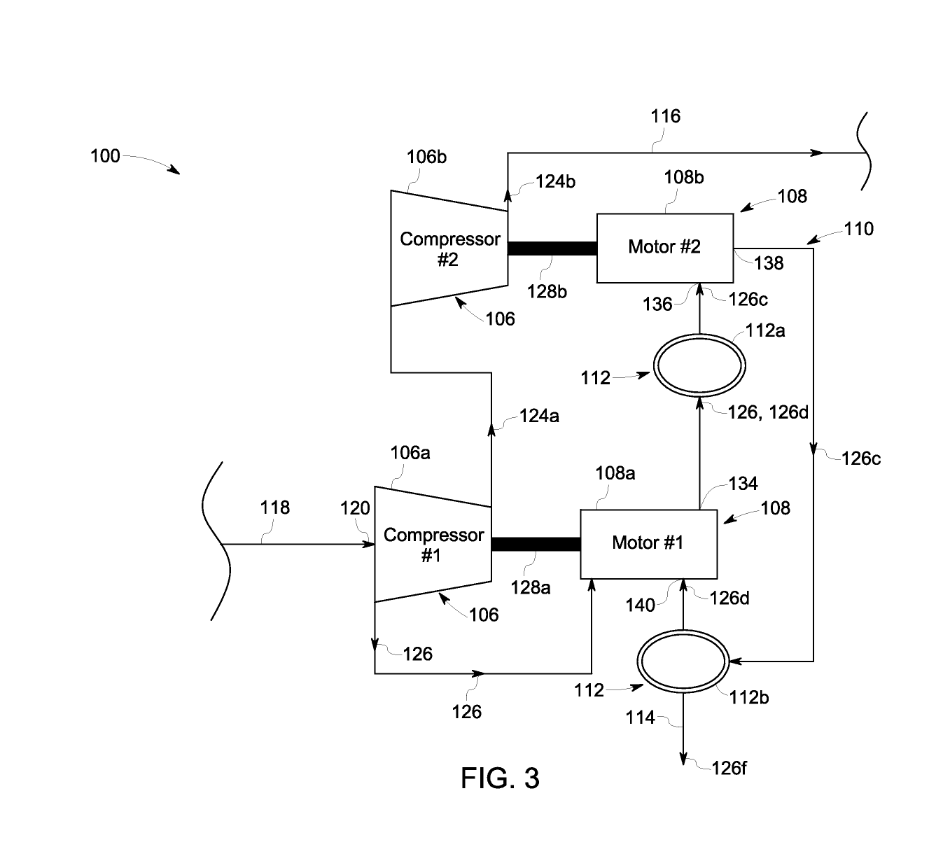

FIG. 3 represents the fluid processing system 100 having the plurality of compressors 106, a plurality of motors 108, and a plurality of energy-dissipating devices 112 in accordance with the exemplary embodiments of FIGS. 1 and 2. The plurality of compressors 106 includes the first compressor 106a coupled to a first motor 108a via a first shaft 128a, and the second compressor 106b coupled to a second motor 108b via a second shaft 128b. In the embodiment shown, the first and second compressors 106a, 106b are deployed in series.

In the illustrated embodiment, the secondary fluid re-circulation loop 110 is disposed between the first motor 108a and the second motor 108b. The secondary fluid re-circulation loop 110 includes a first energy-dissipating device 112a deployed between a re-circulation outlet 134 of the first motor 108a and a re-circulation inlet 136 of the second motor 108b, and a second energy-dissipating device 112b deployed between a re-circulation outlet 138 of the second motor 108b and a re-circulation inlet 140 of the first motor 108a. The first motor 108a is configured for ingress and egress of the secondary fluid stream 126. The first energy-dissipating device 112a receives the secondary fluid stream 126 from the first motor 108a and removes excess heat from the secondary fluid stream 126 and produces therefrom a stream 126c of the secondary fluid stream 126. The second motor 108b is configured for ingress and egress of the stream 126c. The second energy-dissipating device 112b receives the stream 126c via the second motor 108b and removes excess heat from the stream 126c to produce therefrom a stream 126d of the secondary fluid stream 126 depleted in condensable components and a stream 126f of the secondary fluid stream 126 enriched in condensable components. The stream 126d is separated from the stream 126f via the purge line 114 so as to feed the stream 126d to the first motor 108a and discharge the stream 126f.

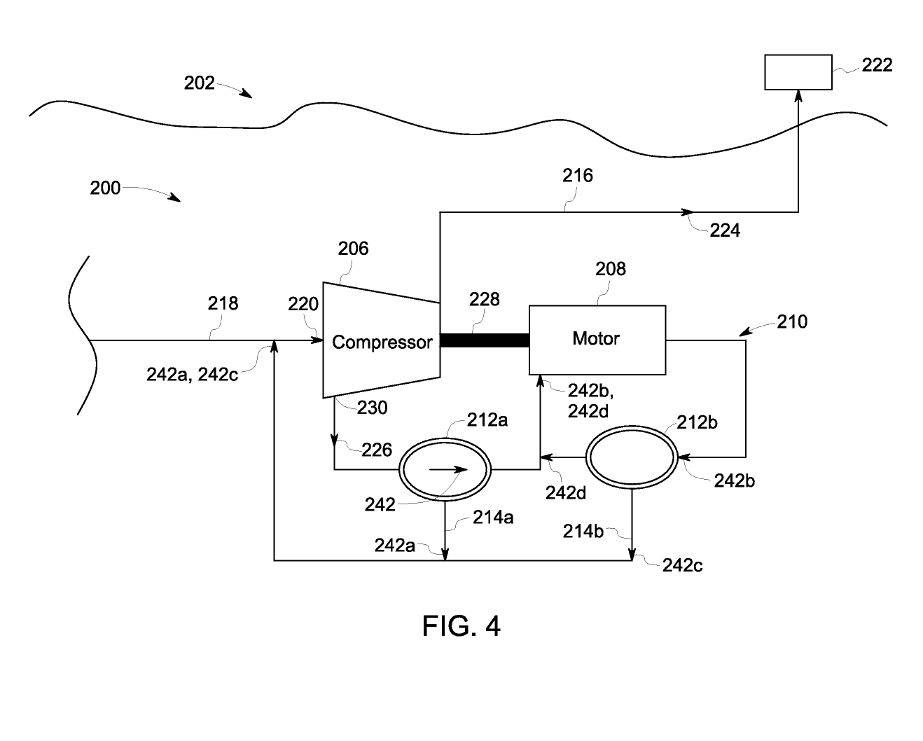

FIG. 4 represents a fluid processing system 200 in accordance with another exemplary embodiment. The fluid processing system 200 includes a compressor 206, a motor 208, a tertiary fluid re-circulation loop 210, a first energy-dissipating device 212a, a second energy-dissipating device 212b, a first purge line 214a, a second purge line 214b, and a fluid conduit 216.

The compressor 206 receives the hot fluid 220 from the subsea hydrocarbon reservoir (as shown in FIG. 1) via an import line 218. The compressor 206 is configured to compress the hot fluid 220 and produce therefrom a primary compressed fluid stream 224 and a secondary fluid stream 226. The motor 208 is coupled to the compressor 206 via a shaft 228, and is configured to drive the compressor 206 so as to compress the hot fluid 220.

The compressor 206 discharges the secondary fluid stream 226 to the first energy-dissipating device 212a via a conduit 230. The first energy-dissipating device 212a removes excess heat from the secondary fluid stream 226 and produces therefrom a tertiary fluid stream 242 having a lower temperature than the secondary fluid stream 226. The tertiary fluid stream 242 includes a first portion 242a enriched in condensable components and a second portion 242b depleted in condensable components. The first purge line 214a separates the first portion 242a from the second portion 242b. In one embodiment, the motor 208 is configured for ingress and egress of the second portion 242b. The second portion 242b is circulated within the motor 208, acts to cools the motor 208, and is discharged from the motor 208 into the tertiary fluid re-circulation loop 210.

The tertiary fluid re-circulation loop 210 includes the second energy-dissipating device 212b configured to receive the second portion 242b. The second energy-dissipating device 212b removes excess heat extracted from the motor 208 from the second portion 242b and produces a third portion 242c of the tertiary fluid stream 242, and a fourth portion 242d of the tertiary fluid stream 242. In one embodiment, the portions 242a and 242c include a condensate, and the portions 242b and 242d include a gaseous fluid stream depleted in condensable components. Specifically, the portions 242a and 242c are enriched in condensable components and the portions 242b and 242d are depleted in condensable components.

The second purge line 214b coupled to the second energy-dissipating device 212b separates the third portion 242c from the fourth portion 242d. In the illustrated embodiment, the first portion 242a discharged via the first purge line 214a and the third portion 242c discharged via the second purge line 214b are combined and delivered to a feed line 218 (i.e. import line or inlet fluid conduit) disposed upstream relative to the compressor 206. In the illustrated embodiment, the portions 242a and 242c are naturally discharged from the purge lines 214a and 214b to the feed line 218 (which may alternatively be referred as “a low pressure sink” or “a low pressure destination”). In certain other embodiments, the portions 242a, 242c may be transported to a high pressure sink such as the outlet fluid conduit 216 located downstream of the compressor 206, through a boosting device (not shown in FIG. 4) disposed within the purge lines 214a and 214b. Similarly, in the illustrated embodiment at steady state a mixture of the second portion 242b along with the fourth portion 242d is circulated through the motor 208 via the tertiary fluid re-circulation loop 210. In one embodiment, the tertiary fluid re-circulation loop 210 functions to control an operating temperature of the motor 208.

The outlet fluid conduit 216 is coupled to the compressor 206 for receiving the primary compressed fluid stream 224 from the compressor 206 and directing the primary compressed fluid stream 224 to a fluid storage facility 222.

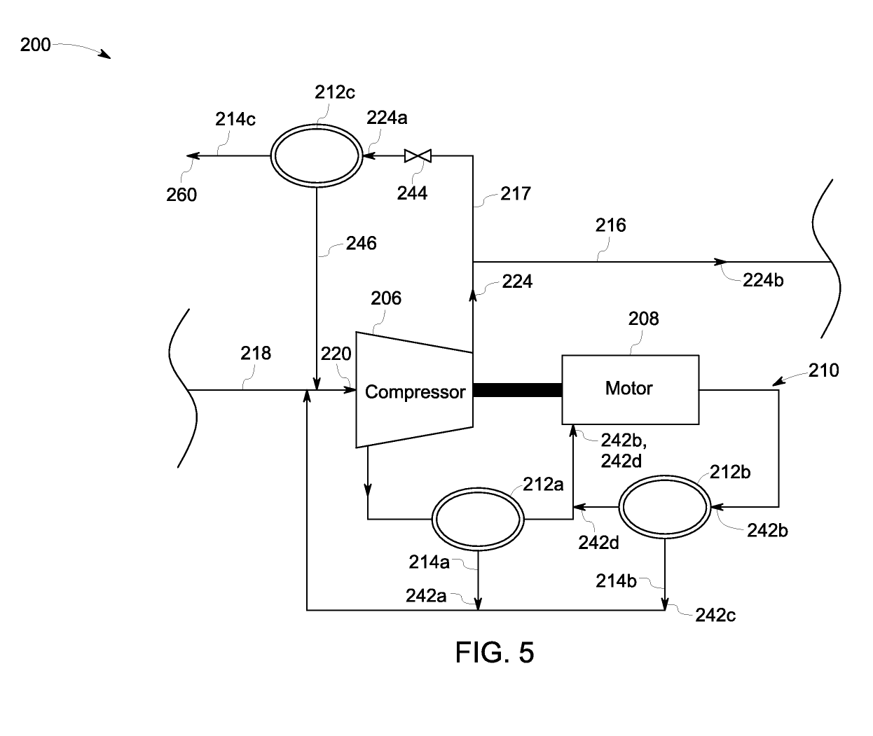

FIG. 5 represents the fluid processing system 200 having a flow control valve 244 in accordance with the exemplary embodiment of FIG. 4. In the illustrated embodiment, the flow control valve 244 is coupled to a return conduit 217 disposed downstream of the compressor 206 and a third energy-dissipating device 212c is disposed on the return conduit 217 and coupled between the flow control valve 244 and the import line 218. The flow control valve 244 is configured to deliver at least a portion 224a of the primary compressed fluid stream 224 to third energy-dissipating device 212c. The outlet fluid conduit 216 receives a remaining portion 224b of the primary compressed fluid stream 224 and directs it to the storage facility 222 (as shown in FIG. 4).

The third energy-dissipating device 212c removes excess heat from the portion 224a and produces a heat-depleted fluid stream 246 depleted in condensable components and a fluid stream 260 enriched in condensable components. The stream 260 is separated from the stream 246 via a third purge line 214c. The third energy-dissipating device 212c delivers the stream 246 to feed line 218 (i.e. input fluid conduit) of the compressor 206. In one embodiment, the flow control valve 244 along with the third energy-dissipating device 212c is configured to mix the stream 246 with the hot fluid 220 and thereby control a temperature of fluid being presented to the compressor 206. In one embodiment, the temperature of the hot fluid 220 is greater than the temperature of the stream 246. In some other embodiments, the temperature of the stream 246 is greater than the temperature of the hot fluid 220.

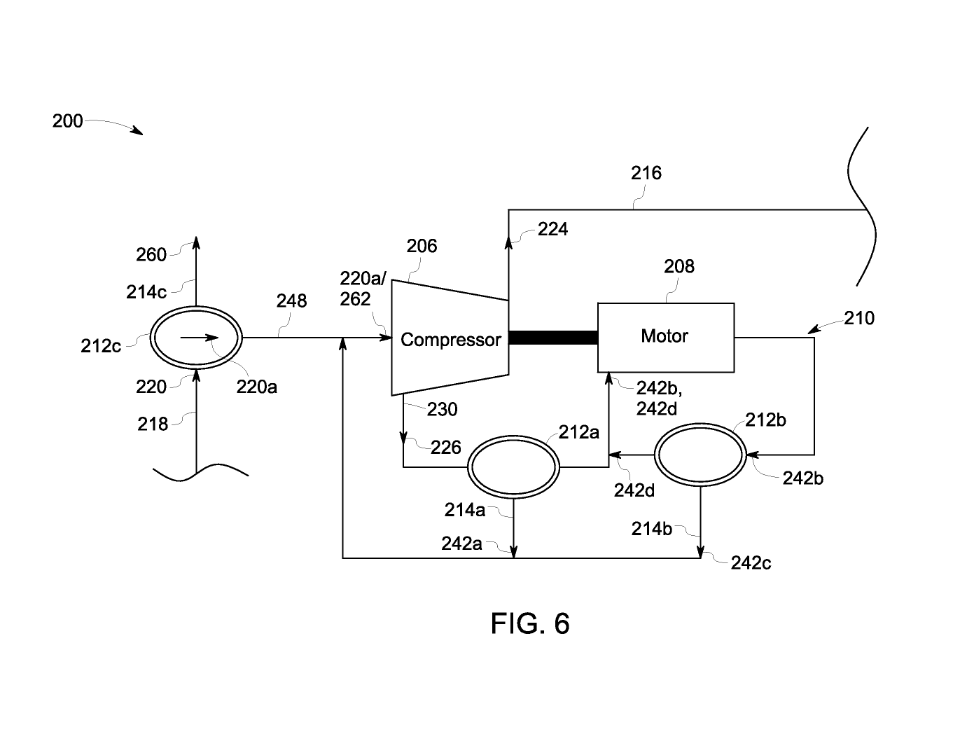

FIG. 6 represents the fluid processing system 200 having a third energy-dissipating device 212c disposed upstream relative to the compressor 206 in accordance with the exemplary embodiment of FIG. 4. The third energy-dissipating device 212c is configured to receive a first hot fluid 220 from the subsea hydrocarbon reservoir (as shown in FIG. 1) via the import line 218. The third energy-dissipating device 212c removes excess heat from the first hot fluid 220 and produces a second hot fluid 220a including condensable and non-condensable components. The second hot fluid 220a includes a condensate 260 and a gaseous fluid stream 262 depleted in condensable components which are separated and removed by third purge line 214c. In the embodiment shown, the temperature of the second hot fluid 220a is less than the temperature of the first hot fluid 220.

The compressor 206 receives the gaseous fluid stream 262 depleted in condensable components from the third energy-dissipating device 212c via feed line 248. In the embodiment shown, the compressor 206 is a dry gas compressor and is configured to compress the gaseous fluid stream 262 and produce therefrom the primary compressed fluid stream 224 and secondary fluid stream 226. The primary compressed fluid stream 224 is directed to the distant storage facility 222 (as shown in FIG. 4) via fluid conduit 216 and the secondary fluid stream 226 is discharged to the first energy-dissipating device 212a via conduit 230.

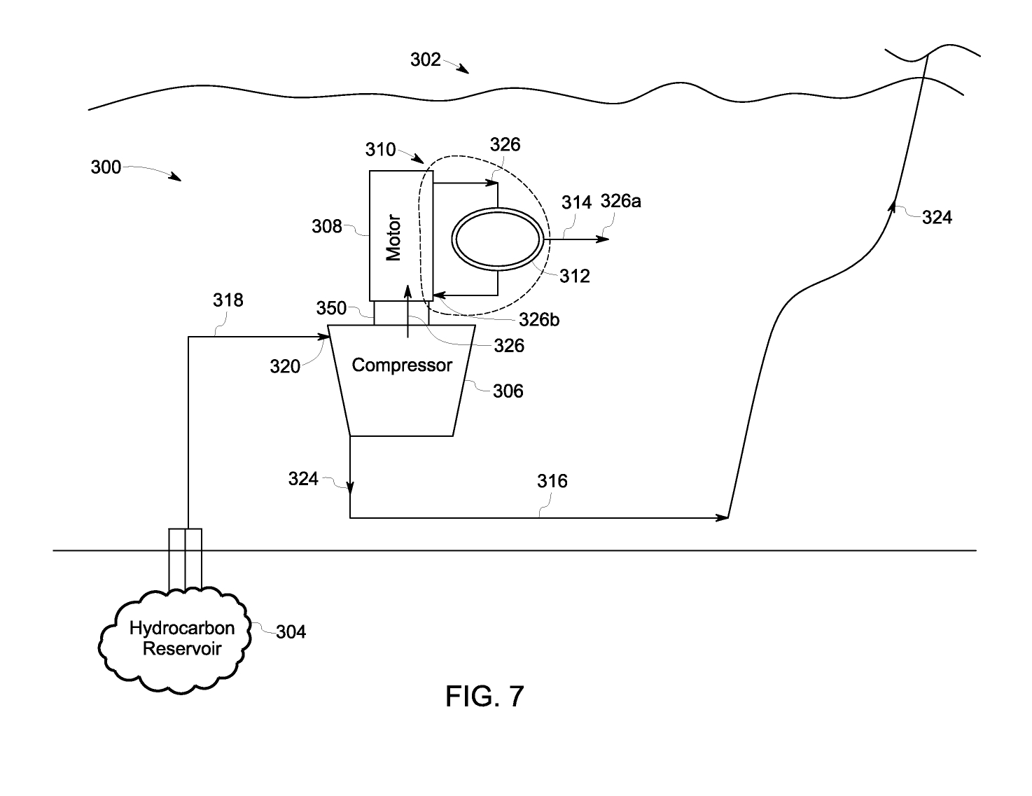

FIG. 7 represents a fluid processing system 300 in accordance with yet another exemplary embodiment. The fluid processing system 300 includes a compressor 306, a motor 308, a secondary fluid re-circulation loop 310, an energy-dissipating device 312, a purge line 314, and a fluid conduit 316. The fluid processing system 300 further includes an import line 318 coupled to the compressor 306.

The compressor 306 receives a hot fluid 320 from a subsea hydrocarbon reservoir 304 via the import line 318. The hot fluid 320 is typically a mixture of a hot gaseous fluid and a hot liquid fluid. The compressor 306 is driven by the motor 308 and is configured to compress the hot fluid 320 and produce therefrom a primary compressed fluid stream 324 and a secondary fluid stream 326. In one embodiment, the motor 308 is coupled to the compressor 306 via a shaft (not shown in FIG. 7) and a permeable seal 350 is disposed between the compressor 306 and the motor 308. In such embodiments, at least a portion of the secondary fluid stream 326 enters the motor 308 via the permeable seal 350, gets circulated within the motor 308, and acts to cool the motor 308 before discharge to the secondary fluid re-circulation loop 310. The permeable seal 350 allows passage of the secondary fluid stream 326 from an initial stage of the compressor 306 to the motor 308 without the need for an additional conduit between the compressor 306 and the motor 308.

The secondary fluid re-circulation loop 310 includes the energy-dissipating device 312 which receives the secondary fluid stream 326 from the motor 308. The energy-dissipating device 312 removes excess heat (i.e. heat extracted from the motor) from the secondary fluid stream 326 and produces a first portion 326a of the secondary fluid stream 326, and a second portion 326b of the secondary fluid stream 326. The first portion 326a is primarily a condensate, and the second portion 326b is primarily a gaseous fluid stream.

The purge line 314 coupled to the energy-dissipating device 312 separates the first portion 326a of the secondary fluid stream 326 from the second portion 326b of the secondary fluid stream 326. Second portion 326b is re-circulated to the motor 308 via the re-circulation loop 310 so as to control the operating temperature of the motor 308. First portion 326a is appropriately discharged from or recirculated within system 300.

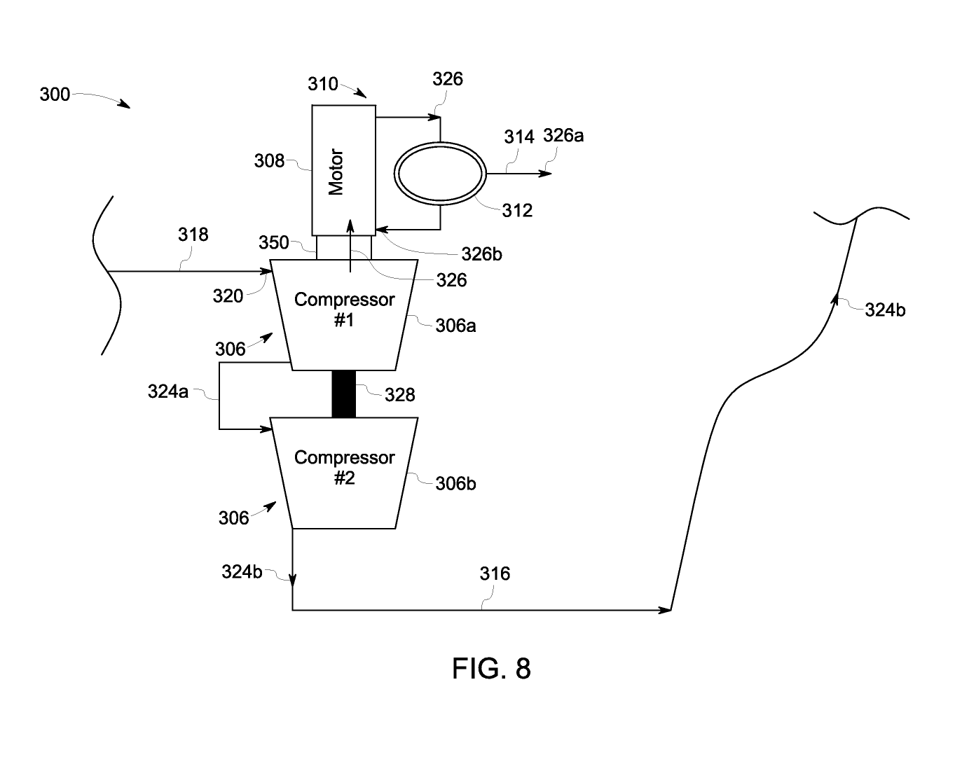

FIG. 8 represents the fluid processing system 300 having a plurality of compressors 306 in accordance with the exemplary embodiment of FIG. 7. The plurality of compressors 306 includes a first compressor 306a and a second compressor 306b deployed in series and driven by a single shaft 328 coupled to the motor 308. The first compressor 306a is configured to compress the hot fluid 320 and produce therefrom first primary compressed fluid stream 324a and secondary fluid stream 326. The first primary compressed fluid stream 324a is fed to the second compressor 306b for further compression. As in FIG. 7, the secondary fluid stream 326 enters the motor 308 via the preamble seal 350 for cooling the motor 308. The secondary fluid stream 326 after extracting heat from the motor 308 is discharged to the secondary fluid recirculation loop 310. The energy-dissipating device 312 coupled to the secondary fluid recirculation loop 310 removes heat from the secondary fluid stream 326 and produces therefrom first portion 326a and second portion 326b of the secondary fluid stream 326. Further, second portion 326b is recirculated to the motor 308 through the secondary recirculation loop 310 and first portion 326a is removed from the system 300 via purge line 314. The second compressor 306b receives the first primary compressed fluid stream 324a from the first compressor 306a and produces a second primary compressed fluid stream 324b which is directed to the distant fluid storage facility (as shown in FIG. 4) via the outlet fluid conduit 316.

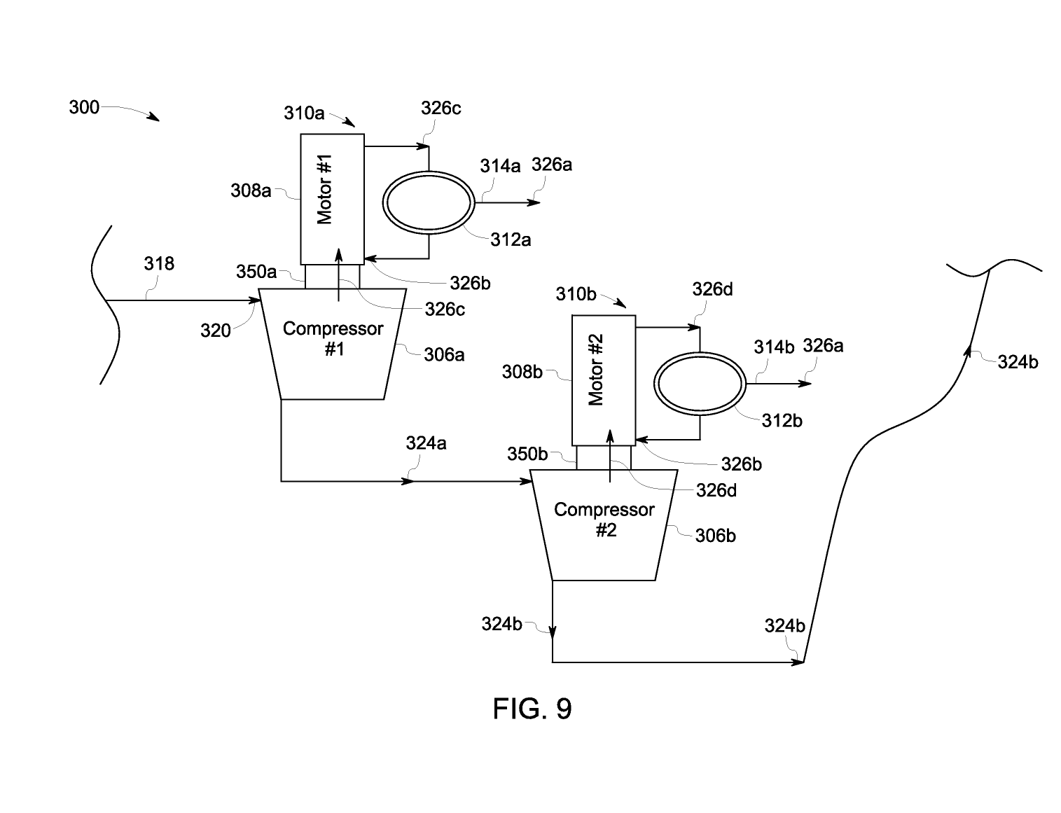

FIG. 9 represents a fluid processing system 300 having a plurality of compressors 306, a plurality of motors 308, a plurality of secondary recirculation loops 310, and a plurality of energy-dissipating devices 312 in accordance with the exemplary embodiments of FIGS. 7 and 8. The plurality of compressors 306 includes a first compressor 306a coupled to a first motor 308a via a first shaft (not shown in FIG. 9), and a second compressor 306b coupled to a second motor 308b via a second shaft (not shown in FIG. 9). The first and second compressors 306a and 306b are deployed in series. In the illustrated embodiment, a first permeable seal 350a is disposed between the first compressor 306a and the first motor 308a and a second permeable seal 350b is disposed between the second compressor 306b and the second motor 308b. A first energy-dissipating device 312a is coupled to a secondary recirculation loop 310a and a second energy-dissipating device 312b is coupled to a secondary recirculation loop 310b. Further, a first purge line 314a is coupled to the first energy-dissipating device 312a and a second purge line 314b is coupled to the second energy-dissipating device 312b. In such embodiments, the secondary fluid stream 326 produced from the first compressor 306a, enters first the first motor 308a via the first permeable seal 350a. Secondary fluid stream 326 produced from the second compressor 306b, enters the second motor 308b via the second permeable seal 350b.

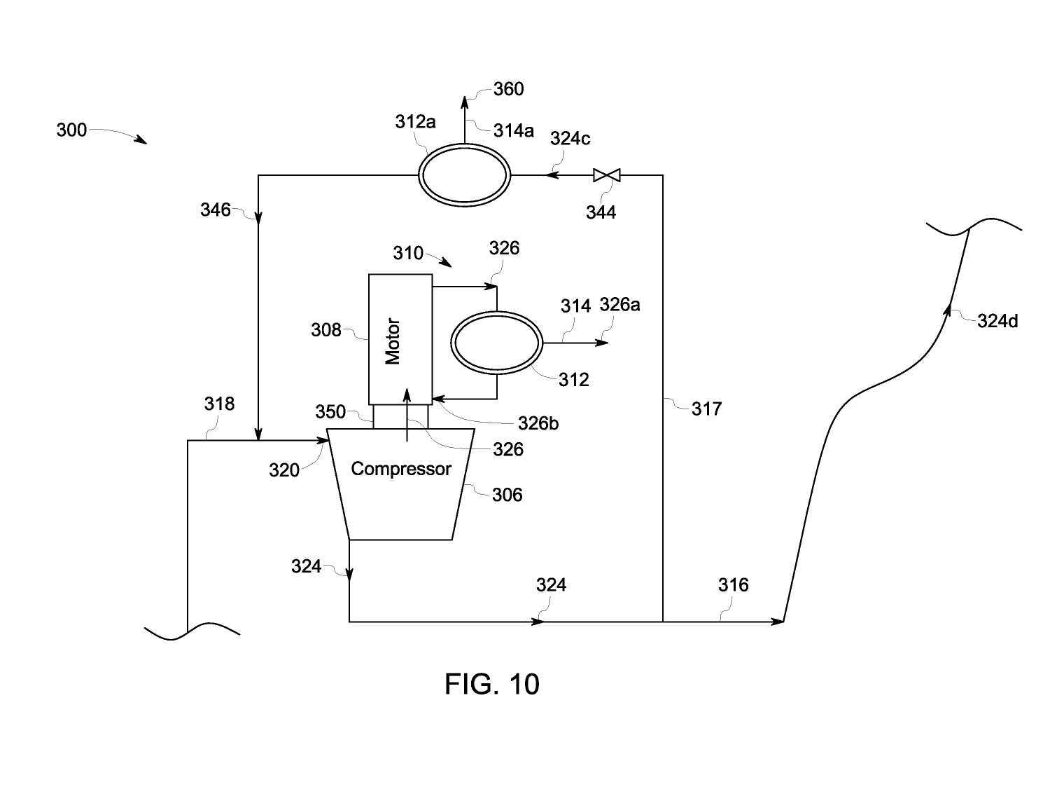

FIG. 10 illustrates a schematic view of the fluid processing system 300 having a flow control valve 344 in accordance with the exemplary embodiment of FIG. 7. In the illustrated embodiment, the flow control valve 344 is coupled to a return conduit 317 disposed downstream of the compressor 306 and a first energy-dissipating device 312a is disposed on the return conduit 317 and coupled between the flow control valve 344 and the import line 318. The flow control valve 344 is configured to deliver at least a portion 324c of the primary compressed fluid stream 324 to the first energy-dissipating device 312a. The outlet fluid conduit 316 receives remaining portion 324d of the primary compressed fluid stream 324 and directs to a distant storage facility (as shown in FIG. 4).

The first energy-dissipating device 312a is configured to remove excess heat from the portion 324c and produces a heat depleted fluid stream 346 depleted in condensable components and a fluid stream 360 enriched in condensable components. Stream 360 is separated from stream 346 via a first purge line 314a and removed from the system 300 via first purge line 314a. The first energy-dissipating device 312a delivers the stream 346 to the feed line 318 upstream of the compressor 306. In one embodiment, the flow control valve 344 and the first energy-dissipating device 312a function to control a temperature of the hot fluid 320 being presented to the compressor 306 from the subsea hydrocarbon reservoir 304 (as shown in FIG. 7). In one embodiment, the temperature of the hot fluid 320 is greater than the temperature of the stream 346. In some other embodiments, the temperature of the stream 346 is greater than the temperature of the hot fluid 320.

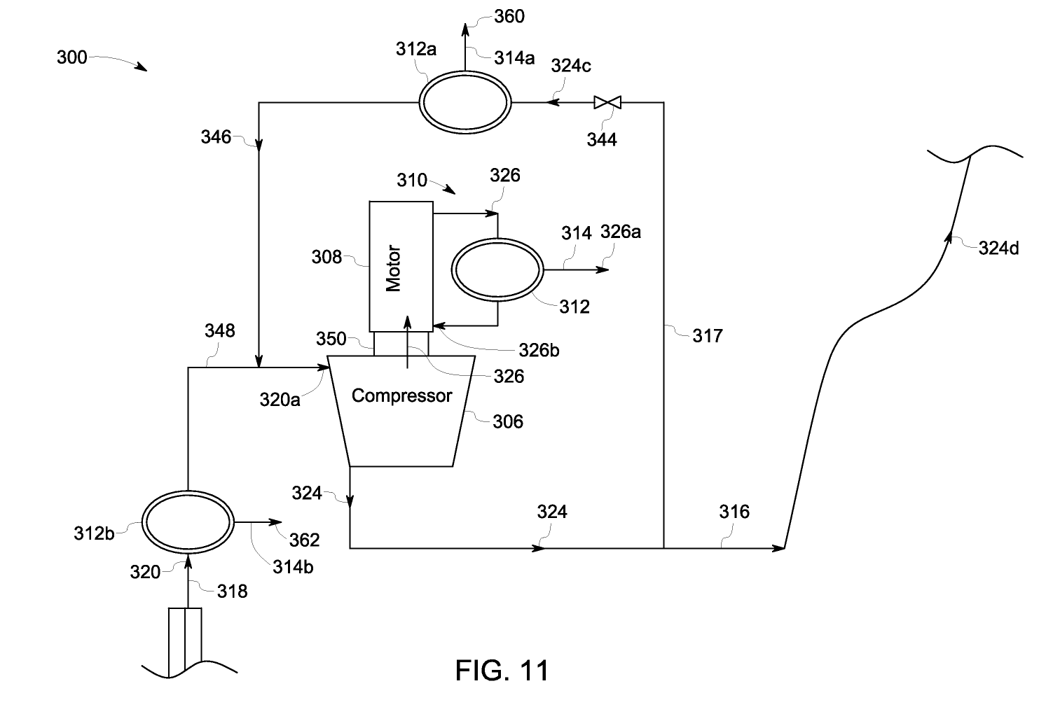

FIG. 11 represents the fluid processing system 300 in accordance with the exemplary embodiments of FIGS. 7 and 10. The fluid processing system 300 includes a third energy-dissipating device 312b disposed upstream relative to the compressor 306 and is configured to receive the first hot fluid 320 from the subsea hydrocarbon reservoir 304 (as shown in FIG. 7) via the import line 318. The second energy-dissipating device 312b removes excess heat from the first hot fluid 320 and produces second hot fluid 320a including condensable and non-condensable components. Purge line 314b separates a condensable component 362 from the non-condensable components and the condensable components 362 are removed from the system 300 via the second purge line 314b. In the embodiment shown, the temperature of the second hot fluid 320a is less than the temperature of the first hot fluid 320.

The compressor 306 receives the hot fluid 320a from the second energy-dissipating device 312b via a feed line 348. The compressor 306 is configured to compress the hot fluid 320a and produce therefrom the primary compressed fluid stream 324 and a secondary fluid stream 326 which are treated as described herein.

In accordance with certain embodiments discussed herein, the fluid processing system facilitates an efficient way of transporting a hot fluid from a subsea hydrocarbon reservoir to a distant storage facility. In doing so, the fluid processing system of the present invention acts to limit sludge and/or hydrate formation. Further, an energy-dissipating device separates a condensate from a gaseous fluid and feeds the gaseous fluid to a motor for cooling the motor and thus avoids fouling or scaling the motor and recirculation lines vital for cooling the motor. Condensate produced in an energy-dissipating device may be recirculated to a point upstream of the compressor so as to enhance the production, allow steady and continuous operation of the system, and prevent pressure variation-related damage to the compressor.

While only certain features of embodiments have been illustrated and described herein, many modifications and changes will occur to those skilled in the art. It is, therefore, to be understood that the appended embodiments are intended to cover all such modifications and changes as falling within the spirit of the invention.

1. A fluid processing system comprising:
(a) a compressor configured to receive a hot fluid comprising condensable and non-condensable components, and produce therefrom a primary compressed fluid stream and a secondary fluid stream;
(b) a motor configured to drive the compressor, the motor being configured for ingress and egress of the secondary fluid stream;
(c) a secondary fluid re-circulation loop configured to control an operating temperature of the motor, the secondary fluid re-circulation loop comprising a first energy-dissipating device configured to remove excess heat from the secondary fluid stream;
(d) a purge line configured to separate a first portion of the secondary fluid stream in the fluid re-circulation loop from a second portion of the secondary fluid stream being returned to the motor; and
(e) a fluid conduit configured to receive the primary compressed fluid stream from the compressor.

2. The fluid processing system according to claim 1, wherein the first energy-dissipating device comprises a heat exchange sub-system configured to receive the secondary fluid stream and condense at least a portion of the condensable components.

3. The fluid processing system according to claim 1, wherein the first energy-dissipating device comprises a work extraction device selected from the group consisting of turboexpanders, hydraulic expanders, and hydraulic motors.

4. The fluid processing system according to claim 1, wherein the first energy-dissipating device is a pressure changing device comprising a throttle valve.

5. The fluid processing system according to claim 1, wherein at least a portion of the secondary fluid stream enters the motor via a seal disposed between the compressor and the motor.

6. The fluid processing system according to claim 1, wherein the first portion of the secondary fluid stream is enriched in condensable components and the second portion of the secondary fluid stream is depleted in condensable components.

7. The fluid processing system according to claim 1, wherein the purge line is configured to deliver the first portion of the secondary fluid stream to a feed line upstream of the compressor.

8. The fluid processing system according to claim 1, further comprising a flow control valve configured to deliver at least a portion of the primary compressed fluid stream to a feed line upstream of the compressor and to control a temperature of the hot fluid comprising condensable and non-condensable components being presented to the compressor.

9. The fluid processing system according to claim 1, further comprising a second energy-dissipating device disposed upstream of the compressor.

10. The fluid processing system according to claim 1, wherein the compressor is a wet gas compressor.

11. The fluid processing system according to claim 10, wherein the compressor is configured to compress a gas saturated with one or more condensable components.

12. A fluid processing system comprising:
(a) a compressor configured to receive a hot fluid comprising condensable and non-condensable components, and produce therefrom a primary compressed fluid stream and a secondary fluid stream;
(b) a first energy-dissipating device configured to receive the secondary fluid stream and produce therefrom a tertiary fluid stream having a lower temperature than the secondary fluid stream;
(c) a motor configured to drive the compressor, the motor being configured for ingress and egress of the tertiary fluid stream;
(d) a tertiary fluid re-circulation loop configured to control an operating temperature of the motor, the tertiary fluid re-circulation loop comprising a second energy-dissipating device configured to remove excess heat from the tertiary fluid stream;
(e) a purge line configured to separate a first portion of the tertiary fluid stream in the fluid re-circulation loop from a second portion of the tertiary fluid stream being returned to the motor; and
(f) a fluid conduit configured to receive the primary compressed fluid stream from the compressor.

13. The fluid processing system according to claim 12, wherein at least one of the first and second energy-dissipating device comprises a heat exchange sub-system configured to receive the secondary and tertiary fluid stream respectively and condense at least a portion of the condensable components.

14. The fluid processing system according to claim 12, wherein at least one of the first and second energy-dissipating device comprises a work extraction device selected from the group consisting of turboexpanders, hydraulic expanders, and hydraulic motors.

15. The fluid processing system according to claim 12, wherein at least one of the first and second energy-dissipating device is a pressure changing device comprising a throttle valve.

16. The fluid processing system according to claim 12, wherein at least a portion of the tertiary fluid stream enters the motor as a mixture of fresh tertiary fluid from the first energy-dissipating device and the second portion of the tertiary fluid stream being cycled through the tertiary fluid re-circulation loop.

17. The fluid processing system according to claim 12, wherein the first portion of the tertiary fluid stream is enriched in condensable components and the second portion of the tertiary fluid stream is depleted in condensable components.

18. The fluid processing system according to claim 17, wherein the purge line is configured to deliver the first portion of the tertiary fluid stream and a portion of the tertiary fluid from the first energy-dissipating device to a feed line upstream of the compressor.

19. A method comprising:
(a) introducing a hot fluid comprising condensable and non-condensable components into a compressor to produce a primary compressed fluid stream and a secondary fluid stream;
(b) feeding the secondary fluid stream from the compressor to a motor configured to drive the compressor, to control an operating temperature of the motor;
(c) circulating the secondary fluid stream in a secondary fluid re-circulation loop configured to receive the secondary fluid stream from the motor, the secondary fluid re-circulation loop comprising an energy-dissipating device configured to remove excess heat from the secondary fluid stream;
(d) separating a first portion of the secondary fluid stream from a second portion of the secondary fluid stream via a purge line;
(e) re-circulating the second portion of the secondary fluid stream to the motor; and
(f) transporting the primary compressed fluid stream from the compressor to a fluid storage facility via a fluid conduit.

20. The method of claim 19, wherein the energy-dissipating device is configured to receive the secondary fluid stream and condense at least at least a portion of the secondary fluid stream to produce thereby the first portion of the secondary fluid stream comprising a condensate, and the second portion of the secondary fluid stream comprising a gaseous fluid stream depleted in condensable components.

21. The method of claim 19, wherein the energy-dissipating device is configured to receive the secondary fluid stream and reduce pressure of at least a portion of the secondary fluid stream so as to produce thereby the first portion of the secondary fluid stream comprising a condensate, and the second portion of the secondary fluid stream comprising a gaseous fluid stream depleted in condensable components.

22. The method of claim 19, wherein the energy-dissipating device is configured to expand the secondary fluid stream to produce thereby the first portion of the secondary fluid stream comprising a condensate, and the second portion of the secondary fluid stream comprising a gaseous fluid depleted in condensable components.

23. The method of claim 19, wherein the first portion of the secondary fluid stream is enriched in condensable components and the second portion of the secondary fluid stream is depleted in condensable components, and wherein the first portion of the secondary fluid stream is delivered via a purge line to a feed line upstream of the compressor.

24. The method of claim 19, further comprising feeding at least a portion of the primary compressed fluid stream to a feed line upstream of the compressor, via a flow control valve and controlling a temperature of the hot fluid comprising condensable and non-condensable components being presented to the compressor.

25. A method comprising:
(a) introducing a hot fluid comprising condensable and non-condensable components into a compressor to produce a primary compressed fluid stream and a secondary fluid stream;
(b) feeding the secondary fluid stream from the compressor to a first energy-dissipating device configured to remove heat from the secondary fluid stream and condense one or more condensable components of the secondary fluid stream, and to produce thereby a tertiary fluid stream depleted in condensable components and having a lower temperature than the secondary fluid stream;
(c) feeding the tertiary fluid stream to a motor configured to drive the compressor, to control an operating temperature of the motor;
(d) circulating the tertiary fluid stream in a tertiary fluid re-circulation loop configured to receive the tertiary fluid stream from the motor, the tertiary fluid re-circulation loop comprising a second energy-dissipating device configured to remove excess heat from the tertiary fluid stream;
(d) separating a first portion of the tertiary fluid stream from a second portion of the tertiary fluid stream via a purge line;
(e) re-circulating the second portion of the tertiary fluid stream to the motor; and
(f) transporting the primary compressed fluid stream from the compressor to a fluid storage facility via a fluid conduit.

26. The method of claim 25, wherein the first portion of the tertiary fluid stream is enriched in condensable components and the second portion of the tertiary fluid stream is depleted in condensable components, and wherein the first portion of the tertiary fluid stream and a portion of the tertiary fluid stream from the first energy-dissipating device, are delivered to a feed line upstream of the compressor, via a purge line.
